(19) United States
(12) Patent Application Publication
(10) Pub. No.: US 2024/0174529 A1
(43) Pub. Date: May 30, 2024

(54) BARIUM TITANATE POWDER, PRODUCTION METHOD THEREFOR, AND FILLER FOR SEALING MATERIAL

(71) Applicant: DENKA COMPANY LIMITED, Tokyo (JP)

(72) Inventors: Kazuki HIROTA, Tokyo (JP); Junya NITTA, Tokyo (JP); Yasutaka OSHIMA, Tokyo (JP); Takahisa MIZUMOTO, Tokyo (JP); Hiroaki YOSHIGAI, Tokyo (JP)

(73) Assignee: DENKA COMPANY LIMITED, Tokyo (JP)

(21) Appl. No.: 18/283,246

(22) PCT Filed: Feb. 28, 2022
(86) PCT No.: PCT/JP2022/008403

§ 371 Date: Sep. 21, 2023

(30) Foreign Application Priority Data
Mar. 22, 2021 (JP) 2021-047553

(51) Int. Cl. C01G 23/00

(52) U.S. Cl. CPC C01G 23/006; C01P 2004/32; C01P 2004/61; C01P 2006/40

(57) ABSTRACT

A method for producing a barium titanate-based powder, the method including: step a of spraying a raw material including a barium titanate-based compound into a high-temperature field heated to a temperature equal to or higher than a melting point of the compound to form barium titanate-based particles; and step b of heating a powder including the barium titanate-based particles formed in step a at 700 to 1300° C.

### TECHNICAL FIELD

The present invention relates to a barium titanate-based powder, a method for producing the same, and a filler for a sealing material.

### BACKGROUND ART

Barium titanate-based compounds are known as materials having very high dielectric constants and are widely used as fillers and the like in various electronic component materials (for example, a sealing material or the like) that are required to have higher dielectric constants.

Barium titanate-based compounds themselves have high dielectric constants; however, the dielectric constants thereof as fillers vary depending on the production method therefor. Therefore, various methods for producing a barium titanate-based powder having a high dielectric constant have been examined.

For example, Patent Literature 1 discloses a method for producing a barium titanate powder by atomizing a barium titanate-type raw material into a high-temperature flame. According to this method, a barium titanate powder having a high dielectric constant is obtained.

### CITATION LIST

### Patent Literature

Patent Literature 1: Japanese Unexamined Patent Publication No. 2017-24925

### SUMMARY OF INVENTION

### Technical Problem

In recent years, there is a demand for the development of materials having higher dielectric constants as materials dealing with millimeter waves utilized in the 5th generation (5G) mobile communication systems (for example, a filler for a sealing material used for technologies such as antenna-in-package).

Thus, it is a main object of the present invention to provide a barium titanate-based powder having a higher dielectric constant and a method for producing the same.

### Solution to Problem

An aspect of the present invention provides a method for producing a barium titanate-based powder, the method including: step a of spraying a raw material including a barium titanate-based compound into a high-temperature field heated to a temperature equal to or higher than a melting point of the compound to form barium titanate-based particles; and step b of heating a powder including the barium titanate-based particles formed in step a at 700 to 1300° C.

According to the production method of the above-described aspect, a barium titanate-based powder having a higher dielectric constant can be obtained.

According to an embodiment, the method for producing a barium titanate-based powder may further include step c of classifying a powder including the barium titanate-based particles formed in step a to obtain a plurality of powders having different average particle sizes. In this case, in step b, among the plurality of powders obtained in step c, a powder having an average particle size of 5.0 μm or less and a true specific gravity of 5.60 to 5.90 g/cm³ may be used as the powder including the barium titanate-based particles formed in step a.

Another aspect of the present invention provides a barium titanate-based powder, which is a powder including barium titanate-based particles and has a dielectric constant at 1 GHz of 200 to 330.

According to an embodiment, the barium titanate-based powder may have an average particle size of 3.0 to 7.0 μm.

According to an embodiment, the barium titanate-based powder may have an average degree of sphericity of 0.80 or more.

Another aspect of the present invention provides a filler for a sealing material, the filler including the barium titanate-based powder according to the above-described aspect.

### Advantageous Effects of Invention

According to the present invention, a barium titanate-based powder having a higher dielectric constant and a method for producing the same can be provided.

### DESCRIPTION OF EMBODIMENTS

In the present specification, a numerical value range expressed using the term “to” represents a range including the numerical values described before and after the term “to” as the minimum value and the maximum value, respectively. Furthermore, the units of the numerical values described before and after the term “to” are the same, except for a case where the units are specifically indicated. With regard to a numerical value range described stepwise in the present specification, the upper limit value or lower limit value of a numerical value range of a certain stage may be replaced with the upper limit value or lower limit value of a numerical value range of another stage. Furthermore, with regard to a numerical value range described in the present specification, the upper limit value or lower limit value of the numerical value range may be replaced with a value indicated in the Examples. Furthermore, upper limit values and lower limit values described individually can be combined arbitrarily.

Suitable embodiments of the present invention will be explained below. However, the present invention is not intended to be limited to the following embodiments.

A method for producing a barium titanate-based powder according to an embodiment includes: step a of spraying a raw material including a barium titanate-based compound into a high-temperature field heated to a temperature equal to or higher than a melting point of the compound to form barium titanate-based particles; and step b of heating a powder including the barium titanate-based particles formed in step a at 700 to 1300° C.

The above-described method can also be said to be a method of increasing the dielectric constant of the barium titanate-based powder. In the above-described method, the dielectric constant of the powder obtained in step a can be increased by carrying out step b after step a. For that reason, according to the above-described method, it is possible to obtain a barium titanate-based powder having a higher dielectric constant.

Furthermore, according to the above-described method, it is also possible to further increase the degree of sphericity and the tetragonal ratio. That is, according to the above-described method, a barium titanate-based powder having an average degree of sphericity close to 1 and a tetragonal ratio close to 100% can be obtained.

The above-described method may further include step c of classifying a powder including the barium titanate-based particles formed in the above-described step a to obtain a plurality of powders having different average particle sizes. This step c may be carried out after step a and before step b, or may be carried out simultaneously with step a.

Each of the steps (step a, step b, and step c) in the method for producing a barium titanate-based powder will be described below.

<Step a>

In step a, a raw material including a barium titanate-based compound is melted and solidified by spraying the raw material into a high-temperature field, and barium titanate-based particles having a high degree of sphericity are formed.

The raw material is a solid (for example, particles) including a barium titanate-based compound. Generally, perovskite-type oxides such as barium titanate have a crystal structure of ABO₃. Regarding site A and site B, substitution of elements at both sites with other elements is likely to occur easily, and it is possible to substitute a heteroelement such as Nd, La, Ca, Sr, or Zr into the crystal structure. In the present specification, in addition to barium titanate, compounds obtained by substituting the element at the above-described site A and/or site B of barium titanate with a heteroelement are collectively referred to as barium titanate-based compounds. Examples of the barium titanate-based compounds include a compound represented by the following Formula (1) and a compound represented by the following Formula (2).

(Ba₍₁₋ₓ₎Caₓ)(Ti_{(1-y)}Zr_{y})O₃ (1)

wherein in Formula (1), x and y satisfy 0≤x+y≤ 0.4.

LaₓBa₍₁₋ₓ₎Ti_{(1-x/4)}O₃ (2)

wherein in Formula (2), x satisfies 0<x<0.14.

The shape of the raw material is not particularly limited and may be a regular shape or an irregular shape. The raw material may include components other than the barium titanate-based compound (for example, components such as impurities that are unavoidably contained). The content of the barium titanate-based compound in the raw material may be 98 to 100% by mass or may be 99 to 100% by mass, based on the total mass of the raw material.

The average particle size of the raw material may be 0.5 to 3.0 μm or may be 1.0 to 2.5 μm, or 1.5 to 2.0 μm. As the average particle size of the raw material is larger, the average particle size of the barium titanate-based particles obtainable in step a becomes larger, and as the average particle size of the raw material is smaller, the average particle size of the barium titanate-based particles obtainable in step a becomes smaller. When the average particle size of the raw material is in the above-described range, barium titanate-based particles having an average particle size of 3.0 to 7.0 μm are easily obtained in step a. In the present specification, the average particle size is the particle size at a cumulative mass of 50% (D50) in a particle size distribution obtainable by mass-based particle size measurement according to a laser diffraction light scattering method, and can be measured by using a “MASTERSIZER-3000, equipped with wet dispersion unit: Hydro MV” manufactured by Malvern Panalytical, Ltd.

In step a, the raw material may be mixed with a solvent into a slurry form and then used. That is, in step a, a slurry including the raw material and a solvent may be sprayed into the high-temperature field. When a slurry is sprayed, the degree of sphericity of the barium titanate-based particles is likely to be increased by the surface tension of the solvent.

As the solvent, for example, water is used. As the solvent, an organic solvent such as methanol or ethanol can be also used for the purpose of adjusting the calorific value. These may be used singly or may be used as mixtures.

From the viewpoint that it is easy to increase the degree of sphericity of the barium titanate-based particles, the concentration (content) of the raw material in the slurry may be 1 to 50% by mass or may be 20 to 47% by mass or 40 to 45% by mass, based on the total mass of the slurry.

The high-temperature field may be, for example, a high-temperature flame formed in a combustion furnace or the like. The high-temperature flame can be formed by a combustible gas and a supporting gas. The temperature of the high-temperature field (for example, a high-temperature flame) is a temperature equal to or higher than a melting point of the barium titanate-based compound used for the raw material and is, for example, 1625 to 2000° C.

Examples of the combustible gas include propane, butane, propylene, acetylene, and hydrogen. These can be used singly, or two or more kinds thereof can be used in combination. As the supporting gas, for example, an oxygen-containing gas such as oxygen gas can be used. However, the combustible gas and the supporting gas are not limited to these.

Spraying (atomization) of the raw material can be performed by, for example, using a two-fluid nozzle. The spray velocity (supply speed) of the raw material may be 0.3 to 32 kg/h or may be 9 to 29 kg/h or 22 to 27 kg/h. When the spray velocity of the raw material is in the above-described range, the degree of sphericity of the barium titanate-based particles is likely to be increased. In the case of using a slurry, the spray velocity of the raw material in the slurry may be in the above-described range.

At the time of spraying the raw material, a dispersion gas may be used. That is, the raw material (or a slurry including the raw material) may be sprayed while being dispersed in a dispersion gas. As a result, the degree of sphericity of the barium titanate-based particles is likely to be increased. Regarding the dispersion gas, a combustion-supporting gas such as air or oxygen, an inert gas such as nitrogen or argon, and the like can be used. For the purpose of adjusting the calorific value of gases, a combustible gas may be also mixed with an inert gas. From the viewpoint that it is easy to increase the degree of sphericity of the barium titanate-based particles, the supply speed of the dispersion gas may be 20 to 50 m³/h or may be 30 to 47 m³/h or 40 to 45 m³/h.

The barium titanate-based particles formed in the above-described step a may also include components other than a barium titanate-based compound (for example, components such as impurities that are unavoidably contained). The content of the barium titanate-based compound in the barium titanate-based particles may be 98 to 100% by mass or may be 99 to 100% by mass, based on the total mass of the barium titanate-based particles.

The average degree of sphericity of the barium titanate-based particles formed in the above-described step a (average degree of sphericity of a powder including the barium titanate-based particles) is, for example, more than 0.70. In the above-described step a, barium titanate-based particles having an average degree of sphericity of 0.80 or more or 0.85 or more may be obtained by adjustment of the spray velocity of the raw material, use of a slurry, use of a dispersion gas, and the like. Furthermore, when step c that will be described below is carried out, it is also possible to further increase the degree of sphericity by classification. The maximum value of the average degree of sphericity is 1.

In the present specification, the average degree of sphericity means a value measured by the following method. First, a sample powder and ethanol are mixed to prepare a slurry having a concentration of the sample powder of 1% by mass, and the slurry is subjected to a dispersion treatment by using a “SONIFIER 450 (pulverizing horn ¾″ solid type)” manufactured by Branson Ultrasonics Corporation at an output power level of 8 for 2 minutes. The obtained dispersion slurry is dropped with a dropper onto a sample stage coated with a carbon paste. The dropped slurry is left to stand in air on the sample stage until the slurry dries, subsequently osmium coating is performed, and images of this are captured with a scanning electron microscope “JSM-6301F model” manufactured by JEOL, Ltd. Image capturing is performed at a magnification of 3000 times, and an image with a resolution of 2048×1536 pixels is obtained. The obtained image is imported into a photographing computer, an image analysis apparatus “MacView Ver. 4” manufactured by Mountech Co., Ltd. is used, a particle is recognized by using a simple importing tool, and the degree of sphericity is measured from the projection area (A) and the perimeter (PM) of the particle. When the area of a perfect circle corresponding to the perimeter (PM) is designated as (B), the degree of sphericity of the particle is A/B; on the other hand, when a perfect circle (radius r) having the same perimeter as the perimeter (PM) of the sample is assumed, PM=2πr and B=πr2, so that B=π×(PM/2π)², and the degree of sphericity (A/B) of individual particles is A×4π/(PM)². The degrees of sphericity of two hundred particles each having any projected area equivalent circle diameter of 2 μm or more thus obtained are determined, and the arithmetic mean value thereof is taken as the average degree of sphericity.

<Step c>

In step c, a powder including the barium titanate-based particles formed in step a is classified. The method for classification is not particularly limited and may be screen classification or air classification. From the viewpoint of efficiently performing classification, it is preferable to classify the powder including the barium titanate-based particles by directly connecting a collection system line to the lower part of the combustion furnace where step a is carried out, and suctioning the barium titanate-based particles into the combustion furnace through the collection system line by means of a blower installed behind the collection system line (on the opposite side from the combustion furnace). The collection system line may have a cyclone and a bag filter in addition to a thermal exchanger connected to the combustion furnace. The heat exchanger, cyclone, and bag filter may be connected in series in this order. In this case, the powder including the barium titanate-based particles is collected at each of the combustion furnace, heat exchanger, cyclone, and bag filter. The particle size of each powder to be collected can be adjusted by, for example, the suction amount of the blower.

When the above-described collection system line is used in step c, the powder collected at a site toward the upstream direction (side closer to the combustion furnace) tends to have a true specific gravity closer to the specific gravity of the barium titanate-based compound. This is speculated to be because impurities having small specific gravities (barium carbonate and the like) are more likely to be mixed into the powder to be collected at a site toward the downstream direction (side closer to the blower). Furthermore, when the above-described collection system line is used in step c, the degree of sphericity of the powder collected by the cyclone tends to be the highest.

In step c, classification of the powder including the barium titanate-based particles may be performed such that at least one of the obtained powders has an average particle size of 5.0 μm or less. When a powder having the above-described average particle size is used in step b, the dielectric constant of the barium titanate-based powder obtained in step b tends to be further increased. The average particle size of the above-described powder may be 3.0 to 5.0 μm or may be 3.2 to 4.8 μm or 3.5 to 4.5 μm.

<Step b>

In step b, the powder including the barium titanate-based particles formed in step a is heated at a temperature of 700 to 1300° C. to obtain a barium titanate-based powder as a calcination product of the powder.

As the powder including the barium titanate-based particles formed in step a, one of a plurality of powders obtained by classifying the powder including the barium titanate-based particles formed in step a may be used. That is, in step b, one of the powders obtained in step c may be used. In the case of using the above-described collection system line in step c, when a powder collected by the cyclone is used, the dielectric constant of the obtained barium titanate-based powder tends to be further increased.

From the viewpoint that the dielectric constant of the obtained barium titanate-based powder is more likely to be increased, the average particle size of the powder used in step b may be 5.0 μm or less or may be 4.5 μm or less or 4.0 μm or less. The average particle size of the powder used in step b may be 2.0 μm or more, from the viewpoint of preventing aggregation and coalescence of particles during calcination. From these viewpoints, the average particle size of the powder used in step b may be 2.0 to 5.0 μm, 2.0 to 4.5 μm, or 2.0 to 4.0 μm.

In step b, as the true specific gravity of the powder is closer to the specific gravity of the barium titanate-based compound, an effect of increasing the dielectric constant by calcination is easily obtained. From the viewpoint that the dielectric constant of the obtained barium titanate-based powder is more likely to be increased, the true specific gravity of the powder used in step b may be 5.60 to 5.90 g/cm³ or may be 5.60 to 5.80 g/cm³, 5.65 to 5.78 g/cm³, or 5.70 to 5.75 g/cm³. In the present specification, the true specific gravity can be measured by Auto True Denser MAT-7000 model manufactured by Seishin Enterprise Co., Ltd.

From the above-described viewpoint, it is preferable to use a powder having an average particle size of 5.0 μm or less and a true specific gravity of 5.60 to 5.90 g/cm³ in step b. When the above-described collection system line is used in step c, a powder having such an average particle size and such a true specific gravity can be easily obtained by cyclone collection.

The average degree of sphericity of the powder used in step b may be more than 0.80 or may be 0.82 or more, or 0.85 or more. The maximum value of the average degree of sphericity is 1.

For the heating of the powder, a calcination furnace may be used. The heating temperature (for example, temperature inside the calcination furnace) for the powder is 700° C. or higher and may be 800° C. or higher, 900° ° C. or higher, 1000° ° C. or higher, or 1100° C. or higher. As the heating temperature is higher, the tetragonal ratio tends to be increased. The heating temperature of the powder is 1300° ° C. or lower, and from the viewpoint of increasing the degree of sphericity, the heating temperature may be 1200° C. or lower, 1100° ° C. or lower, or 1000° C. or lower. From the viewpoint that the dielectric constant of the obtained barium titanate-based powder is more likely to be increased, the heating temperature of the powder may be 800 to 1200° ° C. or 900 to 1100° C. The temperature increase rate of the powder is not particularly limited; however, the temperature increase rate may be 2 to 5ºC/min or may be 2.5 to 4.5° C./min or 3 to 4° C./min.

From the viewpoint that the dielectric constant of the obtained barium titanate-based powder is more likely to be increased, the heating time of the powder may be 2 hours or more or may be 4 hours or more or 6 hours or more. When the heating time of the powder is 6 hours or more, the tendency of increase in the above-described dielectric constant is lowered, and therefore, from the viewpoint of production efficiency, the heating time of the powder may be 8 hours or less. Incidentally, the above-described heating time does not include the time taken for temperature increase.

The conditions for cooling after heating are not particularly limited. The cooling after heating may be natural cooling inside the furnace.

According to the method for producing a barium titanate-based powder described above, a barium titanate-based powder having a higher dielectric constant can be obtained. Specifically, for example, a barium titanate-based powder having a dielectric constant at 1 GHz of 200 to 330 can be obtained. The dielectric constant at 1 GHz of the barium titanate-based powder can also be set to 250 or more, 280 or more, or 300 or more. That is, according to the above-described method for producing a barium titanate-based powder, a barium titanate-based powder having a dielectric constant at 1 GHz of 250 to 330, 280 to 330, or 300 to 330 can also be obtained. Here, the dielectric constant of the barium titanate-based powder can be measured by using a powder dielectric characteristics measuring device “TM Cavity Resonator” (cylindrical cavity resonance method) manufactured by KEYCOM Corporation. A measured value is a value corrected by inputting the filling weight and the true specific gravity. Incidentally, during the measurement, when filling a measurement cell with a barium titanate-based powder, tapping (dropping into the cell) is performed 10 or more times. As a result, fluctuation can be suppressed by sufficiently decreasing the porosity.

A barium titanate-based powder obtainable by the above-described method tends to have a high degree of sphericity and a high tetragonal ratio. The average degree of sphericity of the barium titanate-based powder is, for example, 0.80 or more and may be set to 0.83 or more, 0.85 or more, 0.87 or more, or 0.88 or more. The maximum value of the average degree of sphericity is 1. In the above-described method, a barium titanate-based powder having an average degree of sphericity close to 1 (for example, 0.80 to 0.99, 0.83 to 0.97, 0.85 to 0.95, 0.87 to 0.93, or 0.88 to 0.90) is obtained. Furthermore, the tetragonal ratio of the barium titanate-based powder is, for example, 65% or more and may be set to 68% or more or 70% or more. The maximum value of the tetragonal ratio is 100%. In the above-described method, a barium titanate-based powder having a tetragonal ratio close to 100% (for example, 65 to 95%, 68 to 85%, or 70 to 75%) is obtained. The tetragonal ratio can be determined by a Rietveld method by measuring an X-ray diffraction (XRD) pattern of the barium titanate powder using a D2 PHASER manufactured by Bruker.

The average particle size of a barium titanate-based powder obtainable by the above-described method is, for example, 3.0 to 7.0 μm. The average particle size of the barium titanate-based powder may be set to 3.2 μm or more or 3.5 μm or more or may be set to 6.5 μm or less, 6.0 μm or less, 5.0 μm or less, 4.5 μm or less, or 4.2 μm or less.

Since a barium titanate-based powder obtainable by the above-described method has a high dielectric constant, the barium titanate-based powder is suitably used in various electronic component materials and is particularly suitably used as a filler for a sealing material, which is required to have a high dielectric constant. Regarding the sealing material, for example, a sealing material used for an antenna-in-package may be mentioned. When using a barium titanate-based powder as a filler for a sealing material, it is also possible to use the barium titanate-based powder as a mixture with other filler components.

### EXAMPLES

The matters of the present invention will be described in more detail below by using Examples and Comparative Examples; however, the present invention is not intended to be limited to the following Examples.

### Comparative Example 1

(Preparation of raw material)

As a raw material, “BT-SA” (trade name, barium titanate powder, average particle size: 1.6 μm) manufactured by KCM Corporation was prepared, and this was mixed with water to prepare a slurry (concentration of BT-SA: 43% by mass).

(Formation of barium titanate particles)

An apparatus including: a combustion furnace in which an LPG-oxygen mixed type burner having a double-tube structure capable of forming inner flames and outer flames was installed at the top, a collection system line directly connected to the lower part of the combustion furnace, and a blower connected to the collection system line, was prepared. The collection system line has a heat exchanger connected to the combustion furnace, a cyclone connected to the upper part of the heat exchanger, and a bag filter connected to the upper part of the cyclone, and the bag filter is connected to the blower.

A high-temperature flame (temperature: about 2000° C.) was formed inside the combustion furnace of the above-described apparatus, and from the central part of the burner, the above-described slurry was entrained into carrier air (supply rate: 40 to 45 m³/h) and sprayed at a supply rate of 37 L/Hr (25 kg/h in terms of BT-SA). The flame was formed by providing several dozen pores at the outlet port of the burner having a double-tube structure and spraying a mixed gas of LPG (supply rate 17 m³/h) and oxygen (supply rate 90 m³/h) through the pores. As a result, spherical-shaped barium titanate particles were formed.

(Classification of powder including barium titanate particles)

A powder including the barium titanate particles formed in the combustion furnace was classified by suctioning with the blower, and a powder including barium titanate particles was collected at each of the combustion furnace, the heat exchanger, the cyclone, and the bag filter. Among the collected plurality of powders, the powder collected by cyclone collection was used as a barium titanate powder of Comparative Example 1.

### Example 1

“Formation of barium titanate particles” and “Classification of powder including barium titanate particles” were carried out in the same manner as in Comparative Example 1, and then a powder collected by cyclone collection was subjected to a calcination treatment. Specifically, 8 kg of the powder collected by cyclone collection was fed into a mullite sheath, heated to 1000° ° C. at a temperature increase rate of 3.3° C./min, and then calcined at 1000° C. for 6 hours to obtain a barium titanate powder of Example 1. Incidentally, the cooling after calcination was performed by natural cooling inside the furnace.

### Examples 2 and 3 and Comparative Example 2

Production of barium titanate powders of Examples 2 and 3 and Comparative Example 2 was attempted in the same manner as in Example 1, except that the temperature at the time of calcination was changed to the temperature shown in Table 1. As a result, in Examples 2 and 3, barium titanate powders could be obtained. On the other hand, in Comparative Example 2 in which the calcination temperature was set to 1400° C., the barium titanate particles were sintered and did not become powdery. For that reason, in the following description, only the barium titanate powders obtained in Examples 1 to 3 and Comparative Example 1 were subjected to analysis and evaluation.

<Analysis and Evaluation>

[Measurement of True Specific Gravity]

The true specific gravities of the barium titanate powders obtained in Examples 1 to 3 and Comparative Example 1 were measured by Auto True Denser MAT-7000 model manufactured by Seishin Enterprise Co., Ltd. The results are shown in Table 1.

[Measurement of Average Degree of Sphericity]

The average degrees of sphericity of the barium titanate powders obtained in Examples 1 to 3 and Comparative Example 1 were measured by the following method. First, a barium titanate powder and ethanol were mixed to prepare a slurry having a concentration of the barium titanate powder of 1% by mass, and the slurry was subjected to a dispersion treatment by using a “SONIFIER 450 (pulverization hom ¾″ solid type)” manufactured by Branson Ultrasonics Corporation at an output power level of 8 for 2 minutes. The obtained dispersion slurry was dropped with a dropper onto a sample stage coated with a carbon paste. The dropped slurry was left to stand in air on the sample stage until the slurry dried, subsequently osmium coating was performed, and images of this were captured with a scanning electron microscope “JSM-6301F model” manufactured by JEOL, Ltd. Image capturing was performed at a magnification of 3000 times, and an image with a resolution of 2048×1536 pixels was obtained. The obtained image was imported into a photographing computer, an image analysis apparatus “MacView Ver. 4” manufactured by Mountech Co., Ltd. was used, and particles were recognized by using a simple importing tool. From the projection areas (A) and the perimeters (PM) of the particles, the degrees of sphericity of two hundred particles each having any projected area equivalent circle diameter of 2 μm or more thus obtained were determined, and the average value thereof was taken as the average degree of sphericity. The results are shown in Table 1.

[Measurement of Average Particle Size]

The average particle sizes (D50) of the barium titanate powders obtained in Examples 1 to 3 and Comparative Example 1 were determined by measuring the particle size on a mass basis according to a laser diffraction light scattering method using a “MASTERSIZER-3000, equipped with wet dispersion unit: Hydro MV” manufactured by Malvern Panalytical, Ltd. On the occasion of the measurement, a barium titanate powder and water were mixed, the mixed liquid was subjected to a dispersion treatment by applying an output power of 200 W using an “Ultrasonic Generator UD-200 (equipped with a microtip TP-040)” manufactured by TOMY SEIKO CO., LTD. for 2 minutes as a pretreatment, and then the mixed liquid obtained after the dispersion treatment was dropped on a dispersion unit such that the laser scattering intensity was 10 to 15%. The stirring speed of the dispersion unit stirrer was set to 1750 rpm, and measurement was made without the ultrasonic mode. Analysis of the particle size distribution was performed by dividing the particle size range of 0.01 to 3500 μm into 100 portions. A refractive index of 1.33 was used for water, and a refractive index of 2.40 was used for barium titanate. The results are shown in Table 1.

[Measurement of Tetragonal Ratio]

The tetragonal ratios of the barium titanate powders obtained in Examples 1 to 3 and Comparative Example 1 were determined by a Reitveld method by measuring X-ray diffraction (XRD) patterns of the barium titanate powders using a D2 PHASER manufactured by Bruker. The measurement conditions for XRD were set as follows. The results are shown in Table 1.
Measurement conditions
Irradiated X-ray source: Cu filament (0.4× 12 mm²)
Output power used: 30 KV-10 mA
   Detector: LYNXEYE manufactured by Bruker (1D-semiconductor detector)
Measurement was performed over the range of 20=20° to 100° under the conditions of 0.02°/step and 0.6 seconds/step.

[Measurement of Dielectric Constant]

The dielectric constants of the barium titanate powders obtained in Examples 1 to 3 and Comparative Example 1 were measured by using a powder dielectric characteristics measuring device “TM Cavity Resonator” (cylindrical cavity resonance method) manufactured by KEYCOM Corporation. The results are shown in Table 1.

TABLE 1

| | | | | | Comparative | Comparative |
|---|---|---|---|---|---|---|
| | | Example 1 | Example 2 | Example 3 | Example 1 | Example 2 |
| Calcination temperature (° C.) | | 1000 | 800 | 1200 | — | 1400 |
| Physical | True specific gravity | 5.90 | 5.90 | 5.91 | 5.74 | Not |
| properties | (g/cm³) | | | | | measurable |
| | Average degree of | 0.88 | 0.87 | 0.84 | 0.86 | Not |
| | sphericity (—) | | | | | measurable |
| | Average particle size (μm) | 4.2 | 5.0 | 6.4 | 3.9 | Not |
| | | | | | | measurable |
| | Tetragonal ratio (%) | 71.60 | 68.34 | 73.24 | 61.47 | Not |
| | | | | | | measurable |
| | Relative dielectric | 309 | 280 | 320 | 63 | Not |
| | constant (—) | | | | | measurable |

As shown in the above-described Table 1, in Examples 1 to 3, a barium titanate powder having a high average degree of sphericity and a small average particle size was obtained without sintering of the barium titanate particles due to calcination. Furthermore, it was verified that the barium titanate powders of Examples 1 to 3 that had been subjected to a calcination treatment had higher dielectric constants as compared with the barium titanate powder of Comparative Example 1.

1. A method for producing a barium titanate-based powder, the method comprising:
step a of spraying a raw material comprising a barium titanate-based compound into a high-temperature field heated to a temperature equal to or higher than a melting point of the compound to form barium titanate-based particles; and
step b of heating a powder comprising the barium titanate-based particles formed in the step a at 700 to 1300° C.

2. The method for producing a barium titanate-based powder according to claim 1, further comprising:
step c of classifying a powder comprising the barium titanate-based particles formed in the step a to obtain a plurality of powders having different average particle sizes,
wherein in the step b, among the plurality of powders obtained in the step c, a powder having an average particle size of 5.0 μm or less and a true specific gravity of 5.60 to 5.90 g/cm³ is used as the powder comprising the barium titanate-based particles formed in the step a.

3. A barium titanate-based powder comprising barium titanate-based particles,
wherein the barium titanate-based powder has a dielectric constant at 1 GHz of 200 to 330.

4. The barium titanate-based powder according to claim 3, wherein the barium titanate-based powder has an average particle size of 3.0 to 7.0 μm.

5. The barium titanate-based powder according to claim 3, wherein the barium titanate-based powder has an average degree of sphericity of 0.80 or more.

6. A filler for a sealing material, comprising the barium titanate-based powder according to claim 3.
